(19) United States
(12) Patent Application Publication
(10) Pub. No.: US 2024/0084059 A1
(43) Pub. Date: Mar. 14, 2024

(54) METHOD FOR RECOVERING RESIDUAL MONOMERS IN THE PREPARATION OF VINYL ESTER-ETHYLENE COPOLYMERS

(71) Applicant: WACKER CHEMIE AG, Munich (DE)

(72) Inventors: Michael ANGERER, Burghausen (DE); Bernhard Eckl, Burghausen (DE)

(73) Assignee: Wacker Chemie AG, Munich (DE)

(21) Appl. No.: 18/267,792

(22) PCT Filed: Aug. 27, 2021
(86) PCT No.: PCT/EP2021/073747

§ 371 Date: Jun. 16, 2023

(51) Int. Cl. C08F 218/08

(52) U.S. Cl. CPC C08F 218/08

(57) ABSTRACT

Methods for preparing vinyl ester-ethylene copolymers and methods for recovering residual monomers when preparing the same. The method includes performing a stage (a) where radically initiated polymerization of vinyl esters, ethylene and optionally further ethylenically unsaturated monomers in an aqueous medium is performed. In a stage (b) a polymerization mixture from stage (a) is depressurized producing an ethylene-containing gas phase and an aqueous phase containing vinyl esters and vinyl ester-ethylene copolymers. Where the ethylene-containing gas phase separated off, then absorbed into vinyl esters and the mixture thus obtained is used in the radically initiated polymerization of vinyl esters, ethylene and optionally further ethylenically unsaturated monomers. In a stage (c) the aqueous phase from stage (a) is depressurized forming a gas phase containing vinyl esters and water that is separated off, then condensed and then used in the radically initiated polymerization of vinyl esters, ethylene and optionally further ethylenically unsaturated monomers.

The invention relates to processes for preparing vinyl ester-ethylene copolymers by means of radically initiated polymerization of vinyl esters, ethylene and optionally further ethylenically unsaturated monomers in aqueous medium at a pressure of 5 to 120 bar abs. to recover unreacted monomers.

Polymers based on vinyl esters, ethylene and optionally further monomers, such as vinyl chloride or (meth)acrylic ester, are used especially in the form of aqueous dispersions or water-redispersible polymer powders in many kinds of applications, for example in coating agents or adhesives for a wide variety of different substrates. Such polymers are generally stabilized by protective colloids, such as polyvinyl alcohols, or low molecular weight, surface-active compounds.

High degrees of conversion are the state of the art in industrial-scale polymerization. For example, under polymerization conditions, the polymerization of liquid monomers, such as vinyl acetate or vinyl chloride, is usually completed up to a residual monomer content of <0.1% by weight, preferably <0.05% by weight, and in the case of vinyl chloride <0.01% by weight. Ethylene is partially in the form of a gas during the polymerization at 5 to 120 bar abs., with the result that generally not such as high degrees of ethylene conversion are achieved under the polymerization conditions which are customary on an industrial scale. This is because firstly ethylene polymerizes more slowly than for example vinyl acetate, and secondly ethylene is largely present in the gas phase and there, under the customary conditions of emulsion polymerization or suspension polymerization, cannot participate in the polymerization since, in the case of such polymerization processes, the polymerization reaction only takes place in the liquid phase with participation of the proportion of ethylene which is dissolved in water, monomers and particles.

For economic reasons, industrial-scale polymerization should be completed in the shortest possible periods of time, but this inevitably means that the ethylene used cannot be fully polymerized to completion. Usually, the polymerization is interrupted at a residual ethylene gas content of ≤10% by weight, preferably ≤5% by weight, and the reaction mixture is depressurized. The depressurization procedure usually involves the transfer of the reaction mixture (polymer dispersion+residual gas) from a pressure reactor into an unpressurized reactor, with removal of the residual ethylene.

The latex obtained can then be demonomerized further in a known manner. The excess ethylene is disposed of, generally by combustion.

This procedure corresponding to the state of the art is not sustainable on account of poor monomer utilization and high disposal costs for the residual monomers. Reuse of the ethylene obtained is inhibited by the fact that the residual gas would first have to be recompressed back to high pressure (>80 bar). This energy-intensive process inhibits recycling for economic reasons, since the residual gas would also have to be purified in a complex manner prior to recompression, in order for example to avoid pressure surges during compression.

Various processes for recovering residual ethylene are known from the prior art. For example, in DE10253043 the reaction mixture is depressurized on conclusion of the emulsion polymerization of vinyl esters and ethylene in one step to a pressure of 0.1 to 5 bar abs., and the gas phase with the ethylene-containing residual gas is compressed to a pressure of 2 to 20 bar abs. and finally returned back into the reactor for the emulsion polymerization. For ethylene recovery, WO2007/074075 teaches a complex, multi-stage fractionated cryogenic condensation of ethylene from the residual gas. EP3321292 describes a high-pressure polymerization process at at least 1500 bar for the preparation of ethylene-vinyl copolymers. To recover ethylene and vinyl comonomers, decompression is performed in multiple stages first to 200 to 300 bar, then to 40 to 60 bar and finally to 0.1 to 5 bar, each with removal of the monomer mixtures contained in the gas phase.

The object of the present invention was to provide processes for preparing vinyl ester-ethylene copolymers which make it possible to reuse the largest possible proportions of the obtained residual gas in an economically viable manner for the radically initiated polymerization of vinyl esters and ethylene and preferably to increase the space-time yield.

The invention provides processes for preparing vinyl ester-ethylene copolymers by means of radically initiated polymerization of vinyl esters, ethylene and optionally further ethylenically unsaturated monomers in aqueous medium at a pressure of 5 to 120 bar abs., characterized in that
a) a polymerization mixture is depressurized to a pressure of 1 to 15 bar abs., producing an ethylene-containing gas phase and an aqueous phase containing vinyl esters and vinyl ester-ethylene copolymers,
b) the ethylene-containing gas phase from stage a) is separated off, then absorbed into vinyl esters and the mixture thus obtained is used in the radically initiated polymerization of vinyl esters, ethylene and optionally further ethylenically unsaturated monomers, and
c) the aqueous phase from stage a) is depressurized to a pressure of 0.1 to 0.5 bar abs., forming a gas phase containing vinyl esters and water, which is separated off, then condensed and then used in the radically initiated polymerization of vinyl esters, ethylene and optionally further ethylenically unsaturated monomers.

The polymerization mixture from stage a) is generally an aqueous dispersion produced by radically initiated polymerization of vinyl esters, ethylene and optionally further ethylenically unsaturated monomers in aqueous medium at a pressure of 5 to 120 bar abs.

In the polymerization mixture of stage a), the monomers, particularly the monomers that are liquid under the polymerization conditions, are converted to an extent of preferably 85% to 99% by weight, more preferably 87% to 98% by weight and particularly preferably 90% to 96% by weight. The conversion of the monomers is generally the quotient of the weight of the vinyl ester-ethylene copolymers contained in the polymerization mixture of stage a) and the total weight of the monomers and vinyl ester-ethylene copolymers contained in the polymerization mixture of stage a).

In stage a), the polymerization mixture is depressurized to a pressure of 1 to bar abs., preferably 2 to 10 bar abs. and particularly preferably 2 to 5 bar abs. For this purpose, the polymerization mixture is generally transferred into a low-pressure vessel or phase separation apparatus that is under the appropriate pressure. An ethylene-containing gas phase and an aqueous phase containing vinyl esters and vinyl ester-ethylene copolymers are generally formed.

The ethylene-containing gas phase of stage a) contains ethylene to an extent of preferably 75% by weight, particularly preferably 85% by weight and most preferably 95% by weight, based on the total weight of the ethylene contained in the polymerization mixture of stage a), or based on the total weight of the ethylene contained in the gas phase and the aqueous phase of stage a).

The ethylene-containing gas phase of stage a) contains ethylene to an extent of preferably 50% to 95% by weight, particularly preferably 70% to 90% by weight and most preferably 75% to 90% by weight, based on the total weight of the ethylene-containing gas phase of stage a).

Furthermore, the ethylene-containing gas phase may also contain further constituents, such as vinyl esters, further monomers, water or inert substances, for example nitrogen, argon or saturated hydrocarbons, such as ethane. The proportion of the further constituents is preferably 5% to 50% by weight, particularly preferably 10% to 30% by weight and most preferably 10% to 25% by weight, based on the total weight of the ethylene-containing gas phase of stage a).

The gas phase of stage a) preferably contains ≤20% by weight, particularly preferably ≤10% by weight, of vinyl ester, based on the total weight of vinyl ester in the gas phase and the aqueous phase of stage a). The gas phase of stage a) preferably contains ≤2% by weight, particularly preferably ≤1% by weight, of water, based on the total weight of water in the gas phase and the aqueous phase of stage a).

The aqueous phase of stage a) preferably contains 35% to 65% by weight, particularly preferably 40% to 60% by weight, of vinyl ester-ethylene copolymers. The aqueous phase of stage a) preferably contains 0.5% to 5% by weight, particularly preferably 1% to 3% by weight, of monomers, in particular vinyl esters, such as vinyl acetate. The aqueous phase of stage a) preferably contains 34.5% to 64.5% by weight, particularly preferably 39% to 59% by weight, of water. The figures in % by weight are based on the total weight of the aqueous phase of stage a).

The depressurization in stage a) is preferably performed adiabatically. Before the depressurization in stage a) is performed, the polymerization mixture has a temperature of preferably 75° C. to 120° C., particularly preferably 80° C. to 110° C. After the depressurization in stage a) has been performed, the polymerization mixture has a temperature of preferably 75° C. to 120° C., particularly preferably 80° C. to 110° C.

In stage b), the ethylene-containing gas phase and the aqueous phase containing vinyl esters and vinyl ester-ethylene copolymers of stage a) can be separated in a manner which is customary per se, for example with a phase separator.

The ethylene-containing gas phase b) is generally absorbed into vinyl esters, i.e. generally a starting material of the polymerization. This may be effected for example in mixing devices, for example static mixers, stirrers, mixing tubes or in particular absorption plants. Preferred absorption plants are designed in the form of columns, in particular columns having random packings or structured packings. Preferably, inert substances, such as nitrogen, argon or saturated hydrocarbons, are removed from the mixing device, particularly at the top of the mixing device, for example by way of a pressure-maintaining means, and discharged from the process. The temperature of the vinyl esters is preferably adjusted to 5° C. to 20° C. before entry into the mixing device. In a preferred embodiment, the vinyl esters are conducted into the mixing device in countercurrent to the ethylene-containing gas phase b); the ethylene-containing gas phase b) is absorbed into vinyl esters here. Any further substances contained in the ethylene-containing gas phase b), in particular vinyl esters that passed into the ethylene-containing gas phase in stage a), are preferably condensed in the mixing device and exit the mixing device preferably together with the ethylene absorbed into vinyl ester.

The mixture thus obtained is generally fed into the reactor for the radically initiated polymerization of vinyl esters, ethylene and optionally further ethylenically unsaturated monomers. The mixture may be compressed to the reactor pressure, for example by means of a pump, preferably after leaving the mixing device and/or before being introduced into the reactor.

The mixture obtained in stage b) preferably contains 0.5% to 5% by weight of ethylene, based on the amount of vinyl esters.

In the case of vinyl ester-ethylene copolymers having particularly high ethylene contents or in the case of feedstocks, in particular ethylene, that are particularly highly contaminated with inert substances, it may be advantageous to compress the ethylene-containing gas phase from stage a) before stage b). This may be advantageous for increasing the ethylene recovery rates. A compression ratio of preferably 1.5 to 3 is selected in this case. The compression ratio is the ratio of compressor outlet pressure to compressor inlet pressure. Particularly preferably, compression of the ethylene-containing gas phase from stage a) is dispensed with.

In stage c), the aqueous phase from stage a) is depressurized to a pressure of 0.1 to 0.5 bar abs., preferably 0.15 to 0.4 bar abs., particularly preferably 0.2 to 0.3 bar abs., forming a gas phase containing vinyl esters and water and an aqueous phase containing vinyl ester-ethylene copolymers. The gas phase containing vinyl esters and water of stage c) is generally separated off, then condensed and then used in the radically initiated polymerization of vinyl esters, ethylene and optionally further ethylenically unsaturated monomers. In stage c), any ethylene remaining in the aqueous phase in stage a) is converted, preferably virtually completely, to the gas phase of stage c) and preferably completely or largely dissolved in the condensate of stage c) and preferably used in the radically initiated polymerization. Any ethylene not condensed in stage c) or not dissolved in the condensate of stage c) is preferably discharged via a vacuum pump, in particular together with non-condensed water and vinyl esters and any inert substances.

The depressurization in stage c) is preferably performed adiabatically. Before the depressurization in stage c) is performed, the aqueous phase has a temperature of preferably 75° C. to 120° C., particularly preferably 80° C. to 110° C. In the course of the depressurization in stage c), there is cooling to preferably 20° C. to 50° C., in particular 20° C. to 40° C. The gas phase formed in stage c) and containing vinyl esters and water has a temperature of preferably 50° C. to less than 80° C., in particular to less than 75° C. The depressurization in stage c) may be effected for example in a conventional phase separator.

Alternatively, heat may also be supplied in stage c), for example by heating or preferably by means of steam. Particularly preferably, steam and the aqueous phase are conducted in countercurrent through a separating apparatus, for example a column having random packings or structured packings.

The condensation in stage c) is preferably performed at a temperature of 0° C. to 15° C., particularly preferably 5° C. to 10° C.

In an alternative embodiment, the condensation in stage c) is performed in two stages. The first stage is preferably performed at a temperature of 15° C. to 40° C., particularly preferably 20° C. to 35° C. The second stage is preferably performed at a temperature of 0° C. to 15° C., particularly preferably 5° C. to 10° C. It is possible in this way for water and vinyl esters to be condensed out in succession. This procedure features particular energy efficiency. The two-stage condensation also has the advantage that the first stage mainly produces water as condensate and the second stage mainly produces vinyl esters as condensate. This enables separate workup. For example, the recycling can be carried out only partially in order to discharge water-soluble or vinyl ester-soluble impurities. The condensate is preferably completely recycled into the radically initiated polymerization.

Common condensers may be used. The condensers are preferably connected on the gas side to the phase separator of stage c).

The condensate of stage c) preferably contains 25% to 75% by weight, particularly preferably 40% to 60% by weight, of vinyl esters. The condensate of stage c) preferably contains 25% to 75% by weight, particularly preferably 40% to 60% by weight, of water. These figures in % by weight are each based on the total weight of the condensate of stage c).

The condensate of stage c) preferably contains 25% to 75% by weight, particularly preferably 35% to 65% by weight, of vinyl esters, based on the total weight of the vinyl esters that were contained in the aqueous phase of stage a) containing vinyl esters and vinyl ester-ethylene copolymers. If energy is additionally supplied to stage c), for example in the form of heating power or steam, then the condensate preferably contains 50% to 100% by weight, particularly preferably 90% to 100% by weight, of vinyl esters, based on the total weight of the vinyl esters that were contained in the aqueous phase of stage a) containing vinyl esters and vinyl ester-ethylene copolymers.

Condensate of stage c) is reused in the radically initiated polymerization of vinyl esters and ethylene. Preferably, the condensate is introduced directly or immediately, optionally after temperature adjustment, into the reactor for the radically initiated polymerization of vinyl esters and ethylene, for example using a pump.

What remains in stage c) after the gas phase containing vinyl esters and water has been separated off is generally an aqueous phase containing vinyl ester-ethylene copolymers (aqueous phase from stage c)). This aqueous phase preferably contains ≤2% by weight, particularly preferably 0% to 1% by weight, of vinyl esters, based on the total weight of this aqueous phase containing vinyl ester-ethylene copolymers. This aqueous phase formed in stage c) preferably contains ≤10 ppm, particularly preferably 0 to 5 ppm, of ethylene.

The residual monomer content of the polymer dispersion remaining after stage c) is preferably 1 to 10 000 ppm, particularly preferably 500 to 5000 ppm. If energy is additionally supplied to stage c), for example in the form of heating power or steam, then the residual monomer content is preferably 1 to 1000 ppm, particularly preferably to 100 ppm.

The vinyl ester content of the polymer dispersion after stage c) is for example 50% to 80% by weight lower than at the reactor outlet. If energy is additionally supplied to stage c), for example in the form of heating power or steam, then the vinyl ester content is ≥99% by weight lower than at the reactor outlet.

The aqueous phase formed in stage c) has a temperature of preferably 50° C. to less than 80° C.

After stage c), for the purposes of further residual monomer removal, the aqueous phase from stage c) may be postpolymerized using known methods, generally by redox catalyst-initiated postpolymerization. Volatile residual monomers may also be removed by means of distillation, preferably under reduced pressure, and optionally while passing inert entraining gases, such as air, nitrogen or water vapor, through or over the mixture (stripping).

As an alternative or in addition, the aqueous phase from stage a) may be subject to a postpolymerization or stripping.

It is preferred to subject the aqueous phase from stage a) and also the aqueous phase from stage c) to the postpolymerization or stripping. Particularly advantageously, the two-stage depressurization in steps a) and c) may be linked to a two-stage postpolymerization, in that both the aqueous phase from stage a) (first postpolymerization) and the aqueous phase from stage c) (second postpolymerization) are postpolymerized. The first postpolymerization results in preferably 25% to 90% by weight, particularly preferably 50% to 75% by weight, of the vinyl esters contained in the aqueous phase of stage a) being polymerized to completion. Of the vinyl esters remaining after the first postpolymerization, preferably 25% to 75% by weight, particularly preferably 50% to 75% by weight, are converted to the gas phase in stage c). The vinyl esters then still remaining in the aqueous phase from stage c) may be polymerized to completion in a second postpolymerization. This process variant makes it possible to particularly advantageously achieve low residual monomer contents, of preferably ≤100 ppm, particularly preferably ≤50 ppm.

In the process according to the invention, it is possible to dispense with postpolymerization and stripping, or it is possible for postpolymerization or stripping to be performed in a shorter period of time than in conventional processes, since the residual monomer content has already been reduced by stages a) to c) of the process according to the invention.

The process according to the invention is generally suitable for batch or semi-batch processes and is particularly advantageous for continuous processes.

The thus obtainable aqueous polymer dispersions have a solids content of 30% to 75% by weight, preferably of 50% to 60% by weight.

Suitable vinyl esters are those of carboxylic acids having 1 to 18 carbon atoms. Preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 13 carbon atoms, for example VeoVa⁹ or VeoVal¹⁰ (trade names of Shell). Particular preference is given to vinyl acetate.

Examples of suitable monomers that are copolymerizable with vinyl esters and ethylene are acrylic esters or methacrylic esters of unbranched or branched alcohols having 1 to 18 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate. Particular preference is given to methyl acrylate, methyl methacrylate, n-butyl acrylate, t-butyl acrylate and 2-ethylhexyl acrylate. Also suitable are vinyl halides such as vinyl chloride.

It is optionally also possible to copolymerize 0% to 50% by weight, based on the total weight of the monomer mixture, of auxiliary monomers. 0.1% to 15% by weight of auxiliary monomers are preferably used. Examples of auxiliary monomers are ethylenically unsaturated mono- and dicarboxylic acids; ethylenically unsaturated carboxamides and carbonitriles; ethylenically unsaturated sulfonic acids or salts thereof. Further examples are precrosslinking comonomers, such as polyethylenically unsaturated comonomers, or postcrosslinking comonomers, for example N-methylolacrylamide (NMA). Also suitable are epoxy-functional comonomers such as glycidyl methacrylate and silicon-functional comonomers.

Preference is given to using mixtures of vinyl acetate and ethylene; and mixtures of vinyl acetate and further vinyl esters such as vinyl laurate or vinyl esters of α-branched monocarboxylic acids having 9 to 13 carbon atoms and ethylene; and mixtures of vinyl chloride, ethylene and vinyl esters, for example vinyl laurate.

The monomers and the proportions by weight of the comonomers are selected so as to generally result in a glass transition temperature Tg of −50° C. to +50° C., preferably −20° C. to +20° C. The glass transition temperature Tg of the polymers can be determined in a known manner by means of differential scanning calorimetry (DSC). The Tg may also be approximately calculated in advance by means of the Fox equation. According to Fox T. G., Bull. Am. Physics Soc. 1, 3, page 123 (1956): 1/Tg=x₁/Tg₁+x₂/Tg₂++xₙ/Tgₙ, where xₙ is the mass fraction (% by weight/100) of the monomer n, and Tg n is the glass transition temperature in kelvin of the homopolymer of the monomer n. Tg values for homopolymers are listed in Polymer Handbook 2nd Edition, J. Wiley & Sons, New York (1975).

The polymers are prepared by means of radically initiated polymerization in aqueous medium preferably by the suspension polymerization process and particularly by the emulsion polymerization process, preferably in the presence of protective colloids and/or emulsifiers. Such processes are known per se. The polymerization temperature is generally 40° C. to 100° C., preferably 60° C. to 90° C. The pressure employed during the polymerization is generally from 5 to 120 bar abs.

The polymerization is generally initiated with the water-soluble or monomer-soluble initiators or redox initiator combinations commonly used for emulsion polymerization or suspension polymerization. Examples of water-soluble initiators are the sodium, potassium and ammonium salts of peroxodisulfuric acid, hydrogen peroxide, t-butyl peroxide, t-butyl hydroperoxide, potassium peroxodiphosphate, t-butyl peroxopivalate, cumene hydroperoxide, isopropylbenzene monohydroperoxide, azobisisobutyronitrile. Examples of monomer-soluble initiators are dicetyl peroxydicarbonate, dicyclohexyl peroxydicarbonate, dibenzoyl peroxide. The initiators mentioned are generally used in an amount of 0.01% to 0.5% by weight, based on the total weight of the monomers.

Redox initiators used are generally combinations of the initiators mentioned in combination with reducing agents. Examples of suitable reducing agents are the sulfites or bisulfites of alkali metals and of ammonium, for example sodium sulfite, the derivatives of sulfoxylic acid such as zinc or alkali metal formaldehyde sulfoxylates, for example sodium hydroxymethanesulfinate, and ascorbic acid. The amount of reducing agent is preferably 0.01% to 0.5% by weight, based on the total weight of the monomers.

Substances that act as chain transfer agents can be used during the polymerization to control the molecular weight. If chain transfer agents are used, they are usually used in amounts between 0.01% and 5.0% by weight, based on the monomers to be polymerized. Chain transfer agents can generally be metered in separately or else having been premixed with reaction components. Examples of such substances are n-dodecyl mercaptan, tert-dodecyl mercaptan, mercaptopropionic acid, methyl mercaptopropionate, isopropanol and acetaldehyde. Preference is given to using no substances that act as chain transfer agents.

Examples of suitable protective colloids are partially hydrolyzed polyvinyl alcohols; polyvinylpyrrolidones; polyvinyl acetals; polysaccharides in water-soluble form such as starches (amylose and amylopectin), celluloses and the carboxymethyl, methyl, hydroxyethyl and hydroxypropyl derivatives thereof; proteins such as casein or caseinate, soy protein, gelatin; lignosulfonates; synthetic polymers such as poly(meth)acrylic acid, copolymers of (meth)acrylates with carboxy-functional comonomer units, poly(meth)acrylamide, polyvinylsulfonic acids and the water-soluble copolymers thereof; melamine-formaldehyde sulfonates, naphthalene-formaldehyde sulfonates, styrene-maleic acid copolymers and vinyl ether-maleic acid copolymers. Preference is given to partially hydrolyzed or fully hydrolyzed polyvinyl alcohols.

The protective colloids are generally added in the polymerization in a total amount of 1% to 20% by weight, based on the total weight of the monomers. The portion of protective colloid may for example be completely included in the initial charge or partially included in the initial charge and partially metered in.

Emulsifiers suitable for the polymerization are anionic, cationic or else nonionic emulsifiers. Examples of anionic surfactants are alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl or alkylaryl sulfonates having 8 to 18 carbon atoms, esters and monoesters of sulfosuccinic acid with monohydric alcohols or alkylphenols. Examples of nonionic surfactants are alkyl polyglycol ethers or alkylaryl polyglycol ethers having 8 to 40 ethylene oxide units. In general, the emulsifiers are used in an amount of 0.1% to 5% by weight based on the monomer amount.

By way of the process according to the invention, polymer dispersions having low residual monomer contents are accessible in an advantageous manner. This is also of particular importance if the polymer dispersions are subsequently dried in a spray dryer to form a powder, since it is necessary in this case to remove residual monomers from the dryer waste air in a complex manner in order to comply with emission limits.

The process according to the invention makes it possible to separate off residual vinyl ester and ethylene monomers in a technically simple, efficient, energy-saving and therefore economical manner and to reuse them in the polymerization. Recompression steps with compressors, particularly with multi-stage compressors, or temperature adjustment of vinyl esters and ethylene may be dispensed with in this case. Further steps for purifying the residual gas may be omitted. It is possible in this way to virtually completely recycle the residual vinyl ester and ethylene monomers for the polymerization, with the result that the disposal of residual gas is significantly simplified.

The polymer dispersions are generally concentrated in step c) of the process according to the invention, for example by 1% to 20% by weight, in particular 2% to 8% by weight. As a result, dispersions having a relatively high solids content are accessible in a simple and efficient manner. On the other hand, the polymerization may be carried out at lower solids contents in order to prepare polymer dispersions having the customary solids contents. This reduces fouling during the polymerization and accelerates the removal of heat from the polymerization reactor, which permits an increase in the space-time yield and reduces reactor downtimes for removing fouling.

The examples which follow serve to elucidate the invention in more detail and should in no way be regarded as a restriction.

### Example 1

The following polymer dispersion was removed from the reaction for the emulsion polymerization of vinyl acetate and ethylene:
200 kg/h of aqueous polymer dispersion having a residual monomer content of 3% by weight of vinyl acetate monomer and 0.3% by weight of ethylene (each based on the total weight of the polymer dispersion) at a pressure of 50 bar and a temperature of 95° C.

### Comparative Example 1a

Single-stage depressurization of the polymer dispersion to 1.0 bar:

With the aid of a control valve, the mass flow of the polymer dispersion was depressurized to a pressure of 1.0 bar absolute. As a result, 0.293% by weight of ethylene went into the gas phase, and 70 ppm of ethylene remained in the dispersion. A total offgas stream of 2.5 kg/h was released. This was compressed to 3 bar in order to recover >90% of the ethylene in accordance with the process described in DE10253043, using a cooled liquid ring compressor with an electrical power of 2 kW. The polymer dispersion was then postpolymerized for 1 hour with addition of initiator. The polymer dispersion thus obtained contained 100 ppm of vinyl acetate and 35 ppm of ethylene.

### Comparative Example 1 b

Single-stage depressurization of the polymer dispersion to 0.2 bar: With the aid of a control valve, the mass flow of the polymer dispersion was depressurized to a pressure of 0.2 bar absolute. As a result, 0.2998% by weight of ethylene went into the gas phase and 2 ppm of ethylene remained in the dispersion. A total offgas stream of 13 kg/h was released. This was compressed to 3 bar in order to recover >90% of the ethylene in accordance with the process described in DE10253043, using a cooled liquid ring compressor with an electrical power of 50 kW. The polymer dispersion was then postpolymerized for 1 hour with addition of the same amount of initiator as in Comparative Example 1a.

The polymer dispersion thus obtained contained 30 ppm of vinyl acetate and 1 ppm of ethylene.

### Example 1c

Two-stage depressurization of the polymer dispersion at 3 bar and 0.2 bar: With the aid of a control valve, the mass flow of the polymer dispersion was first depressurized to a pressure of 3 bar absolute. As a result, 0.22% by weight of ethylene went into the gas phase and 700 ppm of ethylene remained in the dispersion. The ethylene thus driven out was dissolved without further compression into the vinyl acetate feed which was then introduced into the polymerization reactor. In a second step, the remaining dispersion was then depressurized to 0.2 bar. A further 698 ppm of ethylene went into the gas phase and only 2 ppm of ethylene remained in the dispersion here. Of the 700 ppm, 650 ppm were dissolved again in the condensation of the VAM, with the result that only 50 ppm is discharged in the offgas.

The polymer dispersion was then postpolymerized for 1 hour with addition of the same amount of initiator as in Comparative Example 1a.

The polymer dispersion thus obtained contained 30 ppm of vinyl acetate and 1 ppm of ethylene.

TABLE
Overview of (Comparative) Examples 1a-c:

| | Comparative | | Comparative | | | |
|---|---|---|---|---|---|---|
| | Example 1a | | Example 1b | | Example 1c | |
| Depressurization pressure | 1 | bar | 0.2 | bar | 1st step: 3 bar; | |
| | | | | | 2nd step: 0.2 bar | |
| Ethylene recovery | >90% | | >90% | | >90% | |
| Electrical energy use | 10 | | 250 | | 0 | |
| [W/kg of dispersion] | | | | | | |
| Residual ethylene in the | 30 | ppm | 1 | ppm | 1 | ppm |
| product | | | | | | |
| Residual vinyl acetate in | 100 | ppm | 30 | ppm | 30 | ppm |
| the product | | | | | | |

1-11. (canceled)

12. A process for preparing vinyl ester-ethylene copolymers, comprising:
performing radically initiated polymerization of vinyl esters, ethylene and optionally further ethylenically unsaturated monomers in an aqueous medium at a pressure of 5 to 120 bar abs.;
performing a stage a) wherein a polymerization mixture is depressurized to a pressure of 1 to 15 bar abs., producing an ethylene-containing gas phase and an aqueous phase containing vinyl esters and vinyl ester-ethylene copolymers;
performing a stage b) wherein the ethylene-containing gas phase from stage a) is separated off, then absorbed into vinyl esters and the mixture thus obtained is used in the radically initiated polymerization of vinyl esters, ethylene and optionally further ethylenically unsaturated monomers; and
performing a stage c) wherein the aqueous phase from stage a) is depressurized to a pressure of 0.1 to 0.5 bar abs., forming a gas phase containing vinyl esters and water, which has a temperature of 50° C. to less than 80° C. and is separated off, then condensed and then used in the radically initiated polymerization of vinyl esters, ethylene and optionally further ethylenically unsaturated monomers.

13. The process of claim 12, wherein the ethylene-containing gas phase of stage a) contains ≥75% by weight of ethylene, based on the total weight of the ethylene contained in the polymerization mixture of stage a).

14. The process of claim 12, wherein the gas phase of stage a) contains ≤20% by weight of vinyl ester, based on the total weight of the vinyl esters contained in the polymerization mixture of stage a).

15. The process of claim 12, wherein the depressurization in stage a) and/or stage c) is performed adiabatically.

16. The process of claim 12, wherein the gas phase formed in stage c) and containing vinyl esters and water has a temperature of 50° C. to less than 75° C.

17. The process of claim 12, wherein the condensation in stage c) is performed at a temperature of 0° C. to 15° C.

18. The process of claim 12, wherein the condensation in stage c) is performed in two stages; and
wherein the first stage is performed at a temperature of 15° C. to 40° C. and the second stage is performed at a temperature of 0° C. to less than 15° C.

19. The process of claim 12, wherein the condensate of stage c) contains 25% to 75% by weight of vinyl esters, based on the total weight of the condensate of stage c).

20. The process of claim 12, wherein the condensate of stage c) contains 25% to 75% by weight of vinyl esters, based on the total weight of the vinyl esters that were contained in the aqueous phase of stage a) containing vinyl esters and vinyl ester-ethylene copolymers.

21. The process of claim 12, wherein energy is supplied to the aqueous phase from stage a) in stage c) and the condensate of stage c) contains 50% to 100% by weight of vinyl esters, based on the total weight of the vinyl esters that were contained in the aqueous phase of stage a) containing vinyl esters and vinyl ester-ethylene copolymers.

22. The process of claim 12, wherein the aqueous phase from stage a) and/or the aqueous phase from stage c) are/is subject to a postpolymerization or stripping.
